(19) United States
(12) Patent Application Publication
(10) Pub. No.: US 2026/0208382 A1
(43) Pub. Date: Jul. 23, 2026

(54) SECONDARY BATTERY ELECTRODE CUTTING DEVICE

(71) Applicant: Yujin Technology Co., Ltd., Chungcheongbuk-do (KR)

(72) Inventors: Hyun Guk YEO, Chungcheongbuk-do (KR); Mi Yeon Lee, Chungcheongbuk-do (KR); Jeon Young Kang, Gyeonggi-do (KR); Sang Keun Yu, Chungcheongbuk-do (KR); Sang Hyun Park, Chungcheongbuk-do (KR); Seon Uk Kim, Chungcheongbuk-do (KR)

(21) Appl. No.: 19/455,326

(22) Filed: Jan. 21, 2026

(30) Foreign Application Priority Data
Jan. 22, 2025 (KR) 10-2025-0009236

(51) Int. Cl. B26D 7/26; B26D 1/00; H01M 10/04

(52) U.S. Cl. CPC B26D 7/2628; B26D 1/0006; B26D 7/2614; H01M 10/0404; B26D 2001/0066

(57) ABSTRACT

The disclosed secondary battery electrode cutting device comprises: a cutting module having an upper blade installed on an upper holder, a lower blade installed on a lower holder, and an adjustment assembly for adjusting a clearance and squareness between the upper blade and the lower blade; a cutting drive unit for operating the upper blade to move up and down toward the lower blade side to cut an electrode sheet; and a cutting byproduct remover for suctioning and discharging cutting byproducts coming from the electrode sheet during cutting of the electrode sheet. The adjustment assembly includes: an upper blade holder support for supporting the upper blade holder; and a clearance adjustment unit and a squareness adjustment unit installed on the upper blade holder support to elastically press and tilt the upper blade holder so that the clearance and squareness between the upper blade and the lower blade are adjusted.

### CROSS-REFERENCE TO RELATED APPLICATIONS

This application is a claims benefit of Korean Patent Application No. 10-2025-0009236, filed on January 22, 2025. The entire disclosure of the applications identified in this paragraph are incorporated herein by references.

### FIELD

The present disclosure relates to a secondary battery electrode cutting device for manufacturing unit electrodes by cutting an electrode sheet.

### BACKGROUND

Generally, a secondary battery is manufactured through an electrode process, an assembly process, a formation process, etc. In the electrode process, electrode tabs (hereinafter referred to as 'tabs') are formed on the uncoated portion of a positive electrode plate or a negative electrode plate (hereinafter referred to as 'electrode') to be manufactured.

Equipment for forming these tabs includes press notching equipment and laser notching equipment. The notching equipment forms tabs on an electrode sheet that is continuously unwound from a roll shape.

The electrode sheet with the tabs formed thereon is cut to a set size to be manufactured as a unit electrode, or is wound again in a roll shape and then cut to a set size while being unwound toward stacking equipment in the assembly process to be manufactured as a unit electrode.

As an apparatus for cutting the aforementioned electrode sheet, a conventional guillotine-type cutting apparatus that cuts the electrode sheet perpendicularly to the transport direction of the electrode sheet is mainly used.

Such a cutting apparatus includes an upper blade, a lower blade, and a cutting drive unit. When the electrode sheet is transported between the upper blade and the lower blade, the cutting drive unit operates the upper blade or the lower blade to move up and down to cut the electrode sheet in the width direction, thereby manufacturing a unit electrode.

In addition, recently, cutting apparatuses having a cartridge-type cutting module that allow the modularized upper and lower blades to be attached to and detached from a cutting drive unit have been disclosed so that the replacement work of the upper and lower blades can be performed simply and easily.

However, the conventional cutting apparatus has a problem in that the work time according to the replacement of the cutting module is prolonged because the clearance and squareness (straightness) between the upper blade and the lower blade cannot be quantitatively adjusted.

In addition, the conventional cutting apparatus has a problem in that cutting byproducts separated from the electrode sheet during cutting are not easily discharged, so they adhere to the manufactured unit electrode. Furthermore, flying debris generated by wear from bearings of the cutting drive unit adheres to the manufactured unit electrode or accumulates between components.

Due to these problems, not only does the quality of the manufactured unit electrode deteriorate and the defect rate increase, but it also acts as a factor in reducing the service life of the cutting apparatus.

Accordingly, the inventors of the present invention have endeavored to prevent the deterioration of quality and the increase in the defect rate of the manufactured unit electrode and to solve the frequent breakdown and reduced lifespan of the cutting apparatus, and as a result, have come to file a patent application for the present invention.

### SUMMARY

### Technical Problem

The objective of the present disclosure is to provide a secondary battery electrode cutting device capable of quantitatively guaranteeing the clearance and squareness between an upper blade and a lower blade.

Another objective of the present disclosure is to provide a secondary battery electrode cutting device capable of suctioning and discharging cutting byproducts separated from an electrode sheet from the entire area of a lower blade.

Another objective of the present disclosure is to provide a secondary battery electrode cutting device capable of preventing the scattering of debris generated by the wear of bearings of a cutting drive unit.

### Technical Solution

To solve the above problems, a secondary battery electrode cutting device according to an aspect of the present disclosure may comprise: a cutting module having an upper blade installed on an upper holder, a lower blade installed on a lower holder, and an adjustment assembly for adjusting a clearance and squareness between the upper blade and the lower blade; a cutting drive unit for operating the upper blade to move up and down toward the lower blade to cut an electrode sheet; and a cutting byproduct remover for suctioning and discharging cutting byproducts coming from the electrode sheet during cutting of the electrode sheet. The adjustment assembly may comprise: an upper blade holder support for supporting the upper blade holder; and a clearance adjustment unit and a squareness adjustment unit installed on the upper blade holder support to elastically press and tilt the upper blade holder so that the clearance and squareness between the upper blade and the lower blade are adjusted.

In the secondary battery electrode cutting device according to an aspect of the present disclosure, the upper blade holder support may comprise: a first mount frame formed to extend in a width direction of the electrode sheet; a second mount frame formed to extend in the width direction of the electrode sheet and fixedly installed to the first mount frame such that a front thereof faces a rear of the first mount frame; and adjustment shafts that horizontally pass through through-holes formed on an upper side of the upper blade holder so as to be spaced apart from each other, and support the upper blade holder between the first and second mount frames such that the upper blade holder can move back and forth and tilt.

In the secondary battery electrode cutting device according to an aspect of the present disclosure, an adjustment groove into which the upper side of the upper blade holder is fitted so as to be movable back and forth and tiltable is formed in the first mount frame, and the adjustment groove may be formed to be opened toward the rear surface side of the first mount frame while extending from a lower portion to an upper side of the first mount frame.

In the secondary battery electrode cutting device according to an aspect of the present disclosure, a first tilting groove into which front ends of the adjustment shafts are tiltably fitted via self-aligning ball bearings is formed in the first mount frame, and a second tilting groove extending in a vertical direction, into which rear ends of the adjustment shafts are tiltably fitted in the vertical direction, may be formed in the second mount frame.

In the secondary battery electrode cutting device according to an aspect of the present disclosure, ball bushings may be fixedly installed in the through-holes so that the upper blade holder can move back and forth along the adjustment shafts.

In the secondary battery electrode cutting device according to an aspect of the present disclosure, the clearance adjustment unit may comprise a plurality of clearance adjustment mechanisms, each mechanism comprising: a clearance adjustment compression coil spring fitted into a clearance adjustment hole formed in the first mount frame such that a rear end thereof can press a front side of the upper blade holder; and a clearance adjustment bolt fastened to be inserted into or withdrawn from the clearance adjustment hole to allow the clearance adjustment compression coil spring to elastically press the front of the upper blade holder.

In the secondary battery electrode cutting device according to an aspect of the present disclosure, the squareness adjustment unit may comprise a plurality of squareness adjustment mechanisms, each mechanism comprising: a squareness adjustment compression coil spring fitted into a first squareness adjustment hole formed at a lower side of the second tilting groove, an upper end of which elastically supports a lower side connected to the rear end of a corresponding one of the adjustment shafts; and a squareness adjustment bolt fastened to be inserted into or withdrawn from a second squareness adjustment hole formed through an upper portion of the second mount frame at an upper side of the second tilting groove, to press an upper side connected to the rear end of the corresponding one of the adjustment shafts so as to tilt the upper blade holder and the upper blade in the vertical direction.

In the secondary battery electrode cutting device according to an aspect of the present disclosure, the cutting drive unit comprises: a lift assembly on which the upper blade holder support is detachably installed; a cutting drive motor for operating the lift assembly up and down; and a lifting support having a vertical plate shape, on a front lower side of which a rear side of the lower holder is detachably installed, and which supports the lift assembly to be capable of lifting. A lifting hole for guiding the lifting of the lift assembly is formed through the inside of the lifting support, guide posts into which the lift assembly is fitted to be capable of lifting are installed on both sides of the lifting hole, and a top frame on which the cutting drive motor is installed may be installed on an upper end side of the lifting support to extend horizontally toward the rear side of the lifting support.

In the secondary battery electrode cutting device according to an aspect of the present disclosure, the cutting drive motor is installed on the top frame such that an output shaft thereof faces the lifting hole. The output shaft of the cutting drive motor is connected to an eccentric shaft via a coupling. An upper end side of a vertically extending crank arm is connected to the eccentric shaft via a bearing, and a crank pin may be installed on a lower end side of the crank arm via a bearing so as to face the lifting hole side.

In the secondary battery electrode cutting device according to an aspect of the present disclosure, the lift assembly comprises: a first lifting block extending from the rear of the lifting support to the front side of the lifting support through the lifting hole; and a second lifting block integrally formed on the front side of the first lifting block. The crank pin is connected to the rear side of the first lifting block. The second lifting block extends in the width direction of the electrode sheet, and a shank groove in which shanks provided on the first mount frame are detachably installed may be formed in a lower portion thereof to extend along a longitudinal direction of the second lifting block.

In the secondary battery electrode cutting device according to an aspect of the present disclosure, a housing accommodating the crank arm, the eccentric shaft, and the crank pin therein is formed at the rear of the first lifting block. The crank arm, the eccentric shaft, and the crank pin accommodated in the housing are confined inside the housing by a cover. The crank pin passes through the housing and is connected to the first lifting block, and an extension end side of the coupling may be accommodated inside the housing through the cover.

In the secondary battery electrode cutting device according to an aspect of the present disclosure, the cutting byproduct remover comprises a trench block extending in the width direction of the electrode sheet and installed at a lower end of the lifting support, on an upper surface of which the lower blade holder is seated. Suction grooves forming a suction and discharge passage for cutting byproducts between the trench block and the lower blade holder may be formed on the upper surface of the trench block along the longitudinal direction of the trench block so as to be closely spaced apart, and a front side thereof may be formed to extend to a front outer side of the lower blade holder.

In the secondary battery electrode cutting device according to an aspect of the present disclosure, the suction grooves are divided into a stepped first region lowering from the front side to the rear side, and a second region. The depth of the second region is formed to be at least twice as deep as the depth of the first region, and a third region inclined downward from the first region toward the second region may be formed between the first region and the second region. In the secondary battery electrode cutting device according to an aspect of the present disclosure, the suction grooves are respectively connected to a discharge port extending along the longitudinal direction of the trench block from the rear side of the trench block via connection holes, and the discharge port may be connected to a suction device provided outside. In the secondary battery electrode cutting device according to an aspect of the present disclosure, a step may be vertically formed on the front side of the trench block.

### Advantageous Effects

According to the present invention, since the adjustment of the clearance and squareness between the upper blade and the lower blade is easy and the clearance and squareness can be quantitatively guaranteed, an effect of maintaining consistent cutting quality is provided.

According to the present invention, since cutting byproducts are suctioned and discharged from the entire area of the lower blade and the bearings of the cutting drive unit are sealed, it is possible to provide an effect of preventing cutting byproducts and scattering debris from adhering to the manufactured unit electrode as well as preventing the scattering debris from accumulating between components.

That is, according to the present invention, it is possible to promote a longer lifespan of the cutting device while reducing the quality degradation and defect rate of the manufactured unit electrode.

### BRIEF DESCRIPTION OF DRAWINGS

FIG. 1 is a cross-sectional view schematically showing a secondary battery electrode cutting device according to the present invention,

FIG. 2 is a perspective view showing the cutting module shown in FIG. 1 in a separated state, and

FIG. 3 is a cross-sectional view taken along line "A-A" of FIG. 2.

### DETAILED DESCRIPTION

Hereinafter, embodiments implementing the secondary battery electrode cutting device according to the present invention will be described in detail with reference to the drawings.

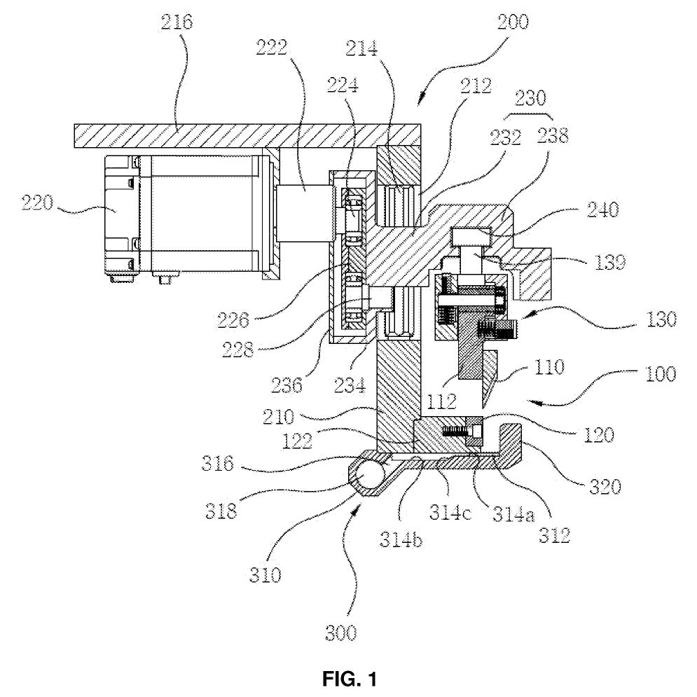

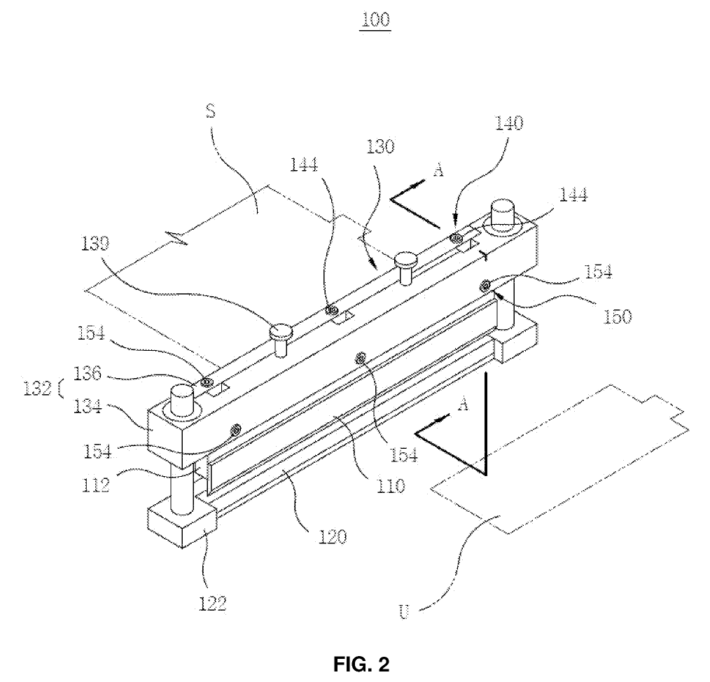

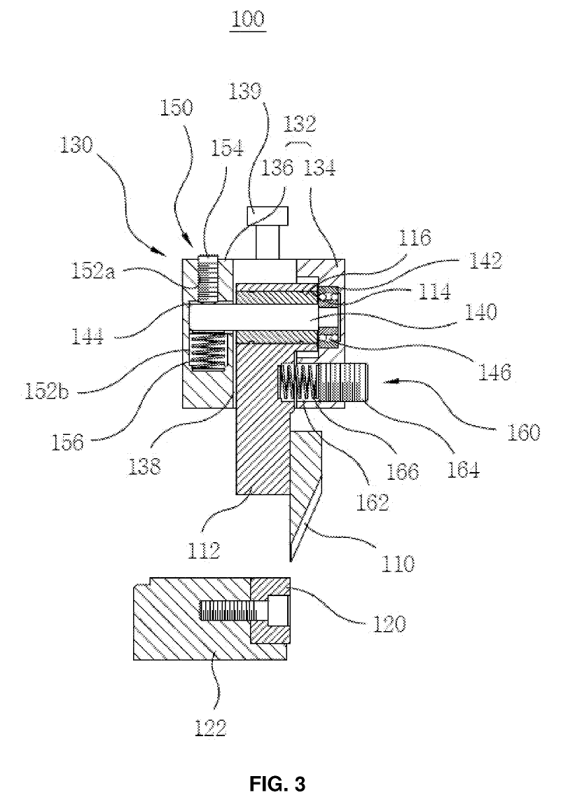

FIGS. 1 to 3 are views schematically showing a secondary battery electrode cutting device according to the present invention.

Referring to FIGS. 1 to 3, the secondary battery electrode cutting device according to the present invention includes a cutting module 100 including an upper blade 110 and a lower blade 120, a cutting drive unit 200 that operates the upper blade 110 to move up and down toward the lower blade 120 to cut an electrode sheet S, and a cutting byproduct remover 300 that suctions and discharges cutting byproducts coming from the electrode sheet S when cutting the electrode sheet S.

The cutting module 100 includes the aforementioned upper blade 110 and lower blade 120, and an adjustment assembly 130 for quantitatively adjusting a clearance and squareness between the upper blade 110 and the lower blade 120. The upper blade 110 and the lower blade 120 extend in the width direction of the electrode sheet S, and the upper blade 110 and the lower blade 120 are similarly installed on the front side of an upper blade holder 112 and a lower blade holder 122 extending in the width direction of the electrode sheet S.

Here, since the connection relationship between the upper blade 110 and the upper blade holder 112 and the connection relationship between the lower blade 120 and the lower blade holder 122 are substantially the same as those of a conventional guillotine-type cutting apparatus, a detailed description thereof will be omitted.

Meanwhile, the upper blade holder 112 is detachably installed on a lower side of a lift assembly 230 of the cutting drive unit 200, and a rear side of the lower holder 122 is detachably installed on a front lower side of a lifting support 210 of the cutting drive unit 200 that supports the lift assembly 230 to be capable of lifting.

The electrode sheet S is transported between the upper blade 110 and the lower blade 120.

The upper blade 110 moves up and down by the operation of the cutting drive unit 200 so that a rear surface side thereof overlaps a front surface side of the lower blade 120, cutting the electrode sheet S to manufacture a unit electrode U.

The adjustment assembly 130 includes an upper blade holder support 132 for supporting the upper blade holder 112, and a clearance adjustment unit 150 and a squareness adjustment unit 160 for adjusting the clearance and squareness between the upper blade 110 and the lower blade 120 by elastically pressing and tilting the upper blade holder 112.

The upper blade holder support 132 includes first and second mount frames 134 and 136, and adjustment shafts 140 supporting the upper blade holder 112 between the first and second mount frames 134 and 136.

The first and second mount frames 134 and 136 are formed to extend in the width direction of the electrode sheet S, and the second mount frame 136 is fixedly installed to the first mount frame 134 via fastening bolts such that a front thereof faces a rear of the first mount frame 134.

At this time, an adjustment groove 138 into which the upper side of the upper blade holder 112 is fitted so as to be movable back and forth and tiltable is formed in the first mount frame 134.

The adjustment groove 138 is formed to be opened toward the rear surface side of the first mount frame 134 while extending from a lower portion to an upper side of the first mount frame 134.

In addition, substantially "T"-shaped shanks 139, which are detachably installed on the lift assembly 230, are formed on the first mount frame 134.

Meanwhile, the adjustment shafts 140 horizontally pass through through-holes 114 formed on the upper side of the upper blade holder 112 so as to be spaced apart at predetermined intervals, and ball bushings 116 are fixedly installed in the through-holes 114 so that the upper blade holder 112 can smoothly move back and forth along the adjustment shafts 140.

The adjustment shafts 140 are inserted into the adjustment groove 138 together with the upper side of the upper blade holder 112 and are tiltably supported by the first and second mount frames 134 and 136.

To this end, first and second tilting grooves 142 and 144 into which front ends and rear ends of the adjustment shafts 140 are tiltably fitted are formed in the first and second mount frames 134 and 136.

At this time, the front ends of the adjustment shafts 140 are fitted into the first tilting groove 142 via self-aligning ball bearings 146, and the second tilting groove 144 is formed in the shape of a long hole extending in the vertical direction so that the rear ends of the adjustment shafts 140 can be tilted in the vertical direction.

That is, the front ends of the adjustment shafts 140 fitted into the first tilting groove 142 via the self-aligning ball bearings 146 serve as a center of rotation during tilting for adjusting the squareness between the upper blade 110 and the lower blade 120.

The clearance adjustment unit 150 and the squareness adjustment unit 160 are installed on the first mount frame 134 and the second mount frame 136, respectively, corresponding to the adjustment shafts 140.

The clearance adjustment unit 150 may include a plurality of clearance adjustment mechanisms, each mechanism including a clearance adjustment bolt 154 and a clearance adjustment compression coil spring 156.

The clearance adjustment compression coil spring 156 is fitted into the first mount frame 134 so that a rear end thereof can press the front side of the upper blade holder 112 inserted into the adjustment groove 138.

To this end, a clearance adjustment hole 152 into which the clearance adjustment compression coil spring 156 is fitted is formed in the first mount frame 134,

and the clearance adjustment bolt 154 is fastened to the clearance adjustment hole 152 so that the clearance adjustment compression coil spring 156 can elastically press the front of the upper blade holder 112.

That is, when the clearance adjustment bolt 154 is inserted into or withdrawn from the clearance adjustment hole 152, the pressure of the clearance adjustment compression coil spring 156 changes.

According to the pressure change of the clearance adjustment compression coil spring 156, the upper blade holder 112 moves back and forth along the adjustment shafts 140, and according to the back and forth movement of the upper blade holder 112, the clearance between the upper blade 110 and the lower blade 120 is quantitatively adjusted.

Meanwhile, the squareness adjustment unit 160 may include a plurality of squareness adjustment mechanisms, each mechanism including a squareness adjustment bolt 164 and a squareness adjustment compression coil spring 166.

The squareness adjustment compression coil spring 166 is fitted into the second mount frame 136 so that an upper end thereof can elastically support a lower side connected to the rear end of the corresponding adjustment shaft 140 fitted into the second tilting groove 144.

The squareness adjustment bolt 164 is fastened to the second mount frame 136 so as to press an upper side connected to the rear end of the corresponding adjustment shaft 140 fitted into the second tilting groove 144.

To this end, a first squareness adjustment hole 162a into which the squareness adjustment compression coil spring 166 is fitted is formed at a lower side of the second tilting groove 144 of the second mount frame 136, and a second squareness adjustment hole 162b into which the squareness adjustment bolt 164 is fastened is formed to pass through the upper portion of the second mount frame 136 at an upper side of the second tilting groove 144.

That is, when the squareness adjustment bolt 164 is inserted into or withdrawn from the second squareness adjustment hole 162b, the rear ends of the adjustment shafts 140 are tilted up and down with the self-aligning ball bearings 146 as the center of rotation.

As the adjustment shafts 140 are tilted up and down, the upper blade holder 112 and the upper blade 110 are tilted in the vertical direction, so that the squareness between the upper blade 110 and the lower blade 120 is quantitatively adjusted.

In the accompanying drawings, three adjustment shafts 140, and the clearance adjustment unit 150 and the squareness adjustment unit 160 having three mechanisms corresponding to the three adjustment shafts 140 are shown, but the number of the adjustment shafts 140 and the mechanisms of the adjustment units 150 and 160 is not limited to three, and they may be added or subtracted according to the lengths of the upper blade 110 and the lower blade 120.

The cutting drive unit 200 includes the lift assembly 230 on which the upper blade holder support 132 is detachably installed, a cutting drive motor 220 for operating the lift assembly 230 up and down, and the lifting support 210 for supporting the lift assembly 230 to be capable of lifting.

The lifting support 210 has a vertical plate shape, and the rear side of the lower holder 122 is detachably installed on the front lower side via fastening bolts as described above.

At this time, a rectangular lifting hole 212 guiding the lifting of the lift assembly 230 is formed through the inside of the lifting support 210, and guide posts 214 into which the lift assembly 230 is fitted to be capable of lifting are installed on both sides of the lifting hole 212.

Also, a top frame 216 on which the cutting drive motor 220 is installed is installed on the upper end side of the lifting support 210 so as to extend horizontally toward the rear side of the lifting support 210.

The cutting drive motor 220 is installed on the top frame 216 such that an output shaft (not shown) faces the lifting hole 212, and the output shaft of the cutting drive motor 220 is connected to an eccentric shaft 224 via a coupling 222.

An upper end side of a vertically extending crank arm 226 is connected to the eccentric shaft 224 via a bearing, and a crank pin 228 is installed on a lower end side of the crank arm 226 via a bearing so as to face the lifting hole 212 side.

The lift assembly 230 includes a first lifting block 232 extending from the rear of the lifting support 210 to the front side of the lifting support 210 through the lifting hole 212, and a second lifting block 238 integrally formed on the front side of the first lifting block 232.

Both sides of the first lifting block 232 are fitted to the guide posts 214 so as to be capable of lifting, and the crank pin 228 is connected to the rear side of the first lifting block 232.

In addition, a housing 234 accommodating the crank arm 226, the eccentric shaft 224, and the crank pin 228 therein is formed at the rear of the first lifting block 232, and the crank arm 226, the eccentric shaft 224, and the crank pin 228 accommodated in the housing 234 are confined inside the housing 234 by a cover 236.

At this time, the crank pin 228 passes through the housing 234 and is connected to the first lifting block 232, and an extension end side of the coupling 222 passes through the cover 236 and is accommodated inside the housing 234.

Preferably, an O-ring (not shown) is interposed between the housing 234 and the cover 236.

Since the crank arm 226 connected to the eccentric shaft 224 and the crank pin 228 is sealed by the housing 234 and the cover 236 in this way, it is possible to fundamentally prevent scattering of debris generated by wear of bearings during cutting of the electrode sheet S.

Meanwhile, the second lifting block 238 extends in the width direction of the electrode sheet S, and a substantially "T"-shaped shank groove 240 is formed in a lower portion thereof to extend along the longitudinal direction of the second lifting block 238.

The shanks 139 provided on the first mount frame 134 of the upper blade holder support 132 supporting the upper blade holder 112 are detachably installed in the shank groove 140 formed in this way.

That is, when the cutting drive motor 220 operates the crank arm 226, the lift assembly 230 moves up and down.

As the lift assembly 230 moves up and down, the upper blade 110 moves up and down toward the lower blade 120 and cuts the electrode sheet S transported between the upper blade 110 and the lower blade 120, thereby manufacturing the unit electrode U.

The cutting byproduct remover 300 includes a trench block 310 extending in the width direction of the electrode sheet S.

The trench block 310 is installed at the lower end of the lifting support 210 via fastening bolts, and the lower blade holder 122 on which the lower blade 120 is installed is seated on the upper surface of the trench block 310.

At this time, suction grooves 312 forming a suction and discharge passage for cutting byproducts between the trench block 310 and the lower blade holder 122 are formed to be recessed on the upper surface of the trench block 310.

The suction grooves 312 are formed along the longitudinal direction of the trench block 310 so as to be closely spaced apart, and the front sides of the suction grooves 312 are formed to extend to the front outer side of the lower blade holder 122.

In addition, the suction grooves 312 are divided into a stepped first region 314a lowering from the front side to the rear side, and a second region 314b, for smooth discharge of cutting byproducts.

The depth of the second region 314b is formed to be at least twice as deep as the depth of the first region 314a.

A third region 314c inclined downward from the first region 314a toward the second region 314b is formed between the first region 314a and the second region 314b of the suction grooves 312 so that cutting byproducts do not accumulate.

Meanwhile, the suction grooves 312 are respectively connected to a discharge port 318 extending along the longitudinal direction of the trench block 310 from the rear side of the trench block 310 via connection holes 316, and the discharge passage 318 is connected to a suction device (not shown) provided outside.

That is, the suction device uses a vacuum pump or the like to extract air to lower the internal pressure of the discharge passage 318, the connection holes 316, and the suction grooves 312.

Thereby, cutting byproducts separated from the electrode sheet S during cutting of the electrode sheet S are suctioned into the front side of the suction grooves 312.

The cutting byproducts suctioned into the front side of the suction groove 312 are collected in the discharge passage 318 through the first region 314a, the third region 314c, the second region 314b, and the connection holes 316, and the cutting byproducts collected in the discharge passage 318 are discharged to the outside by the suction device.

Preferably, a step 320 for guiding cutting byproducts to the front side of the suction groove 312 is formed vertically on the front side of the trench block 310 so as not to interfere with the lifting operation of the upper blade 110.

Since the secondary battery electrode cutting device according to the present invention formed as described above facilitates the adjustment of the clearance and squareness between the upper blade 110 and the lower blade 120 and can quantitatively guarantee the clearance and squareness, it ensures that consistent cutting quality is maintained.

Since the secondary battery electrode cutting device according to the present invention suctions and discharges cutting byproducts from the entire area of the lower blade 120 and seals the bearings of the cutting drive unit 200, it is possible to prevent cutting byproducts and scattering debris from adhering to the manufactured unit electrode U as well as preventing the scattering debris from accumulating between components.

What is claimed is:

1. A cartridge-type secondary battery electrode cutting device comprising:
a cutting module having an upper blade installed on an upper holder, a lower blade installed on a lower holder, and an adjustment assembly for adjusting a clearance and squareness between the upper blade and the lower blade;
a cutting drive unit configured to operate the upper blade to move up and down toward the lower blade to cut an electrode sheet; and
a cutting byproduct remover configured to suction and discharge cutting byproducts generated from the electrode sheet during cutting of the electrode sheet,
wherein the adjustment assembly comprises:
an upper blade holder support supporting the upper blade holder; and
a clearance adjustment unit and a squareness adjustment unit installed on the upper blade holder support to elastically press and tilt the upper blade holder so that the clearance and squareness between the upper blade and the lower blade are adjusted.

2. The cartridge-type secondary battery electrode cutting device of claim 1, wherein the upper blade holder support comprises:
a first mount frame extending in a width direction of the electrode sheet;
a second mount frame extending in the width direction of the electrode sheet and fixedly installed to the first mount frame such that a front surface thereof faces a rear surface of the first mount frame; and
a plurality of adjustment shafts passing horizontally through through-holes formed on an upper side of the upper blade holder to be spaced apart from each other, the adjustment shafts supporting the upper blade holder between the first and second mount frames such that the upper blade holder is movable back and forth and is tiltable.

3. The cartridge-type secondary battery electrode cutting device of claim 2,
wherein an adjustment groove into which the upper side of the upper blade holder is fitted so as to be movable back and forth and tiltable is formed in the first mount frame, and
wherein the adjustment groove is formed to be opened toward the rear surface side of the first mount frame while extending from a lower portion to an upper side of the first mount frame.

4. The cartridge-type secondary battery electrode cutting device of claim 2,
wherein a first tilting groove into which front ends of the adjustment shafts are tiltably fitted via self-aligning ball bearings is formed in the first mount frame, and
wherein a second tilting groove extending in a vertical direction, into which rear ends of the adjustment shafts are tiltably fitted in the vertical direction, is formed in the second mount frame.

5. The cartridge-type secondary battery electrode cutting device of claim 2, wherein ball bushings are fixedly installed in the through-holes so that the upper blade holder can move back and forth along the adjustment shafts.

6. The cartridge-type secondary battery electrode cutting device of claim 2, wherein the clearance adjustment unit comprises a plurality of clearance adjustment mechanisms, each mechanism comprising:
a clearance adjustment compression coil spring fitted into a clearance adjustment hole formed in the first mount frame such that a rear end thereof can press a front side of the upper blade holder; and
a clearance adjustment bolt fastened to be inserted into or withdrawn from the clearance adjustment hole to allow the clearance adjustment compression coil spring to elastically press the front side of the upper blade holder.

7. The cartridge-type secondary battery electrode cutting device of claim 4, wherein the squareness adjustment unit comprises a plurality of squareness adjustment mechanisms, each mechanism comprising:
a squareness adjustment compression coil spring fitted into a first squareness adjustment hole formed at a lower side of the second tilting groove, an upper end of which elastically supports a lower side connected to the rear end of a corresponding one of the adjustment shafts; and
a squareness adjustment bolt fastened to be inserted into or withdrawn from a second squareness adjustment hole formed through an upper portion of the second mount frame at an upper side of the second tilting groove, to press an upper side connected to the rear end of the corresponding one of the adjustment shafts so as to tilt the upper blade holder and the upper blade in the vertical direction.

8. The cartridge-type secondary battery electrode cutting device of claim 2, wherein the cutting drive unit comprises:
a lift assembly on which the upper blade holder support is detachably installed;
a cutting drive motor configured to operate the lift assembly up and down; and a lifting support having a vertical plate shape, on a front lower side of which a rear side of the lower holder is detachably installed, and which supports the lift assembly to be capable of lifting,
wherein a lifting hole for guiding the lifting of the lift assembly is formed through the inside of the lifting support, and guide posts into which the lift assembly is fitted to be capable of lifting are installed on both sides of the lifting hole, and
wherein a top frame on which the cutting drive motor is installed is installed on an upper end side of the lifting support to extend horizontally toward the rear side of the lifting support.

9. The cartridge-type secondary battery electrode cutting device of claim 8,
wherein the cutting drive motor is installed on the top frame such that an output shaft thereof faces the lifting hole, and the output shaft of the cutting drive motor is connected to an eccentric shaft via a coupling, and
wherein an upper end side of a vertically extending crank arm is connected to the eccentric shaft via a bearing, and a crank pin is installed on a lower end side of the crank arm via a bearing so as to face the lifting hole side.

10. The cartridge-type secondary battery electrode cutting device of claim 9, wherein the lift assembly comprises:
a first lifting block extending from the rear of the lifting support to the front side of the lifting support through the lifting hole; and
a second lifting block integrally formed on the front side of the first lifting block,
wherein the crank pin is connected to the rear side of the first lifting block, and
wherein the second lifting block extends in the width direction of the electrode sheet, and a shank groove in which shanks provided on the first mount frame are detachably installed is formed in a lower portion thereof to extend along a longitudinal direction of the second lifting block.

11. The cartridge-type secondary battery electrode cutting device of claim 10,
wherein a housing accommodating the crank arm, the eccentric shaft, and the crank pin therein is formed at the rear of the first lifting block,
wherein the crank arm, the eccentric shaft, and the crank pin accommodated in the housing are confined inside the housing by a cover, and
wherein the crank pin passes through the housing and is connected to the first lifting block, and an extension end side of the coupling passes through the cover and is accommodated inside the housing.

12. The cartridge-type secondary battery electrode cutting device of claim 8,
wherein the cutting byproduct remover includes a trench block extending in the width direction of the electrode sheet and installed at a lower end of the lifting support, on an upper surface of which the lower blade holder is seated, and
wherein suction grooves forming a suction and discharge passage for cutting byproducts between the trench block and the lower blade holder are formed on the upper surface of the trench block along the longitudinal direction of the trench block so as to be closely spaced apart, and a front side thereof is formed to extend to a front outer side of the lower blade holder.

13. The cartridge-type secondary battery electrode cutting device of claim 12,
wherein the suction grooves are divided into a stepped first region lowering from the front side to the rear side, and a second region,
wherein the depth of the second region is formed to be at least twice as deep as the depth of the first region, and
wherein a third region inclined downward from the first region toward the second region is formed between the first region and the second region.

14. The cartridge-type secondary battery electrode cutting device of claim 13,
wherein the suction grooves are respectively connected to a discharge port extending along the longitudinal direction of the trench block from the rear side of the trench block via connection holes, and the discharge port is connected to a suction device provided outside.

15. The cartridge-type secondary battery electrode cutting device of claim 13, wherein a step is vertically formed on the front side of the trench block.
